(19) United States
(12) Patent Application Publication
(10) Pub. No.: US 2026/0268717 A1
(43) Pub. Date: Sep. 10, 2026

(54) SYSTEMS AND METHODS FOR AFFECTING A SET OF ACCESS PERMISSIONS ASSOCIATED WITH A MOVABLE BARRIER OPERATOR

(71) Applicant: THE CHAMBERLAIN GROUP LLC, OAK BROOK, IL (US)

(72) Inventors: Patrick Sebastiaan Van Straalen, New Canaan, CT (US); Ricardo Escobedo, Plainfield, IL (US); Shawn Marghoob Syed, Lisle, IL (US); Satish Nataraja Sundar, Cumming, GA (US); Prakhar Rastogi, Chicago, IL (US); Tracy Rizzi, Kenosha, WI (US)

(21) Appl. No.: 19/559,231

(22) Filed: Mar. 6, 2026

Related U.S. Application Data
(60) Provisional application No. 63/767,890, filed on Mar. 6, 2025.

(51) Int. Cl. G07C 9/10

(52) U.S. Cl. CPC G07C 9/10

(57) ABSTRACT

Systems and methods for affecting a set of access permissions associated with a movable barrier operator are provided. The system includes a plurality of movable barrier operators; a movable barrier operator (MBO) transmitter; one or more processors communicatively connected to the plurality of movable barrier operators and the MBO transmitter; and one or more transitory or non-transitory computer-readable media storing instructions that are executable to cause the one or more processors to perform operations, the operations comprising: receiving a transmitter identifier from the MBO transmitter; processing the transmitter identifier to determine an access level associated with the MBO transmitter; identifying a subset of movable barrier operators from the plurality of movable barrier operators based on the access level; and affecting a set of access permissions between the MBO transmitter and the subset of movable barrier operators based on the access level.

### FIELD

The present disclosure relates generally to systems and methods for affecting a set of access permissions associated with a movable barrier operator.

### BACKGROUND

Managing access permissions associated with a movable barrier operator has long presented a technical challenge to those skilled within the art. Specifically, managing the access permissions surrounding pairing and unpairing transmitters with multiple movable barrier operators has been a time consuming and laborious process. This is true because historically management of the access permissions has involved manually configuring and programing the individual transmitters and their associated buttons to a specific movable barrier operator. When considering that each button associated with the transmitter needs to be paired individually with a specific movable barrier operator, the technical hurdles are exacerbated.

Accordingly, improved systems and methods for affecting a set of access permissions associated with a movable barrier operator are desired in the art. In particular, systems and methods for affecting a set of access permissions associated with a movable barrier operator which expedite the process of configuring and programing the individual transmitters to a specific movable barrier operator would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a system for affecting a set of access permissions associated with a movable barrier operator is provided. The system includes a plurality of movable barrier operators; a movable barrier operator (MBO) transmitter; one or more processors communicatively connected to the plurality of movable barrier operators and the MBO transmitter; and one or more transitory or non-transitory computer-readable media storing instructions that are executable to cause the one or more processors to perform operations, the operations comprising: receiving a transmitter identifier from the MBO transmitter; processing the transmitter identifier to determine an access level associated with the MBO transmitter; identifying a subset of movable barrier operators from the plurality of movable barrier operators based on the access level; and affecting a set of access permissions between the MBO transmitter and the subset of movable barrier operators based on the access level.

In accordance with another embodiment, a method for affecting a set of access permissions associated with a movable barrier operator is provided. The method includes receiving, by a computing device, a transmitter identifier from a MBO transmitter; processing, by the computing device, the transmitter identifier to determine an access level associated with the MBO transmitter; identifying, by the computing device, a subset of movable barrier operators from a plurality of movable barrier operators based on the access level; affecting a set of access permissions between the MBO transmitter and the subset of movable barrier operators based on the access level; receiving a control instruction to change a state of at least one movable barrier operator of the subset of movable barrier operators based on the set of access permissions associated with the MBO transmitter; and causing communication of the control instruction to the at least one movable barrier operator to change the state of the at least one movable barrier operator.

In accordance with a third embodiment, a system for affecting a set of access permissions associated with a movable barrier operator is provided. The system includes a plurality of movable barrier operators; a movable barrier operator (MBO) transmitter; one or more processors communicatively connected to the plurality of movable barrier operators and the MBO transmitter; and one or more transitory or non-transitory computer-readable media storing instructions that are executable to cause the one or more processors to perform operations, the operations comprising: receiving a transmitter identifier from the MBO transmitter; processing the transmitter identifier to determine an access level associated with the MBO transmitter; identifying a subset of movable barrier operators from the plurality of movable barrier operators based on the access level; affecting a set of access permissions between the MBO transmitter and the subset of movable barrier operators based on the access level; updating an operator data structure based on the modification; receiving a control instruction to change a state of at least one movable barrier operator of the subset of movable barrier operators, wherein receiving the control instruction comprises: querying the operator data structure in response to engaging the MBO transmitter; receiving the control instruction based on the querying; and causing communication of the control instruction to the at least one movable barrier operator to change the state of the at least one movable barrier operator.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a block diagram of an exemplary system for affecting a set of access permissions associated with a movable barrier operator in accordance with embodiments of the present disclosure;

FIG. 2 is a block diagram of an exemplary system for generating and maintaining an operator data structure in accordance with embodiments of the present disclosure;

FIG. 3 is a flow diagram of a method for training a machine-learning model to generate the operator data structure in accordance with embodiments of the present disclosure; and

FIG. 4 is a flow diagram of an exemplary method for affecting a set of access permissions associated with a movable barrier operator in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than the limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used in this disclosure, the term “function” refers to a situation where one piece of data or one variable determines the value of another. For example, if a second data point is generated as a function of a first data point, the value of the second data point is computed, at least in part, based on the value of the first data point, e.g., through a specific algorithm or process. This relationship can be represented mathematically or programmatically, where a function takes the first data point as an input and produces the second data point as an output, thereby establishing a direct dependency between them.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure is directed to systems and methods for affecting a set of access permissions associated with a movable barrier operator. The systems and methods disclosed herein are configured to affect a set of access permissions between a plurality of movable barrier operators and a movable barrier operator (MBO) transmitter. These access permissions are designed to selectively allow the MBO transmitter to change a state of the movable barrier operator based on the access levels that is assigned to the MBO transmitter.

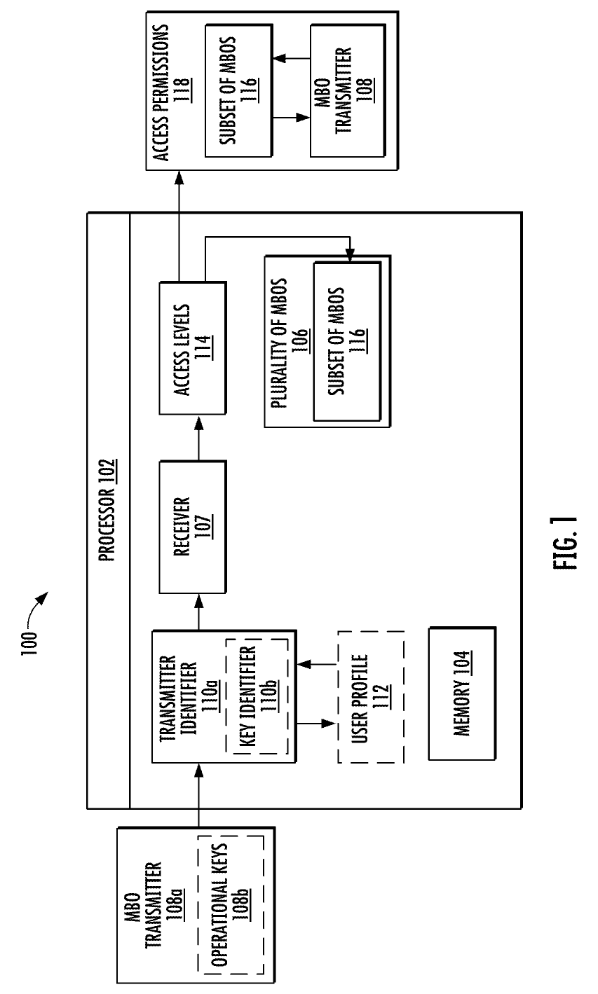

Referring now to the drawings, FIG. 1 is a block diagram of an exemplary system for affecting a set of access permissions associated with a movable barrier operator in accordance with embodiments of the present disclosure. FIG. 1 includes a processor 102, a memory 104, a plurality of movable barrier operators (MBO) 106, a movable barrier operator (MBO) transmitter 108a, an operational key 108b, a transmitter identifier 110a, a key identifier 110b, a user profile 112, an access level 114, a subset of movable barrier operators 116, a set of access permissions 118, and the like.

System 100 includes one or more processors 102 that can be utilized to perform one or more operations. The one or more processors 102 can include any suitable processing device (e.g., a processor core, a microprocessor, an ASIC, a FPGA, a controller, a microcontroller, etc.) and can be one processor or a plurality of processors that are operatively connected. The one or more processors 102 can perform operations in series and/or in parallel. The one or more processors 102 may be dedicated to a particular computing device and/or may be utilized by a plurality of devices to perform processing tasks. In an embodiment, processor 102 could be situated within each of these various computing devices, such as remote computing devices, user devices, laptops, smartphones, smart watches, tablets, computing systems associated with the movable barrier operator, and the like. One or more of these computing devices may be employed to handle specific processing tasks and operations.

Processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. This may be used to train, refine, or otherwise improve any model, algorithm, machine-learning model, neural network, and the like mentioned herein.

Processor 102 may include a single computing device operating independently or may include two or more computing devices operating in concert, in parallel, sequentially, or the like; two or more computing devices may be included together in a single computing device or in two or more computing devices. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more operations as described below across a plurality of computing devices, which may operate in parallel, in series, redundantly, or in any other manner used for the distribution of tasks or memory between computing devices.

System 100 may include memory 104 which can store data and/or instructions. Memory 104 can include one or more non-transitory computer-readable storage mediums, such as RAM, ROM, EEPROM, EPROM, flash memory devices, magnetic disks, etc., and combinations thereof. The data can include user data, application data, operating system data, etc. The data can include text data, image data, audio data, statistical data, latent encoding data, etc. The instructions can include instructions that when executed by one or more of the processors 102 may cause system 100 to perform operations as described herein.

Memory 104 may store data and/or instructions associated with one or more applications. The one or more applications can include native, factory-set applications and/or downloaded applications. The applications may include one or more messaging applications, one or more image capture applications, one or more social media applications, one or more productivity applications, one or more map applications, one or more device management applications, one or more browser applications, and the like. In some implementations, the applications can include one or more applications communicatively connected to one or more server computing systems for providing access to a platform. For example, the applications can include an application for affecting a set of access permissions associated with a movable barrier operator.

### MOVABLE BARRIER OPERATIONS AND MOVABLE BARRIER OPERATOR TRANSMITTERS

System 100 includes a plurality of movable barrier operators (MBO) 106. As used in the current disclosure, a movable barrier operator 106 refers to a mechanical device that controls the opening and closing of a movable barrier. By way of example, the movable barrier can include a gate, a garage door, a house door, a lock, and the like. Each movable barrier operator 106 may be configured to actuate the movable barrier between two or more positions to selectively allow people, goods, and/or vehicles access to a secured area selectively secured by the movable barrier. In a non-limiting example, the movable barrier operator 106 may include a garage door opener and/or an actuator used to move a gate or barrier arm. In an embodiment, the movable barrier may include one or more garage doors, automated locks, alarm systems, lift gates, sliding gates, automatic doors, and/or other controllable devices.

System 100 includes a movable barrier operator (MBO) transmitter 108a. As used in the current disclosure, a movable barrier operator transmitter refers to a communication device that interacts with the MBO 106. The MBO transmitter 108a is used to send signals to the MBO 106 to engage or disengage its operation, such as to change a state of the movable barrier associated with the MBO 106. The MBO transmitter 108a may communicate the signals to the MBO 106 using a variety of communication techniques. The communication techniques may include, but are not limited to, radio frequency, Bluetooth technology, Wi-Fi technology, Ultra Wide Band (UWB) technology, and the like. In some implementations, communication may occur locally. In other implementations, communication may occur remotely, such as facilitated by a remote processor in communication with the MBO transmitter 108a and the MBO 106.

The MBO transmitter 108a can come in various forms. These forms may include user devices (i.e. smartphone, smartwatch, laptop, tablet, desktop, and the like), key fobs, systems integrated within vehicles, a remote control, a mounted keypad, and the like. The MBO transmitter 108a is designed to work with the plurality of MBOs 106, allowing one or more users to control the state of one or more movable barrier operators using the MBO transmitter 108a.

In an embodiment, the MBO transmitter 108a may include a plurality of operational keys 108b. As used in the current disclosure, an operational key refers to a user interface, such as a button, that a user interacts with to control one or more functions of the MBO 106. These operational keys 108b may be used as an interface for the user to select functionality to be communicated between the MBO 106 and the MBO transmitter 108a for sending signals, such as transmitter identifiers 110a-b and control instructions.

The operational keys 108b may take different forms, such as one or more physical buttons and/or one or more digital buttons. Physical operational keys 108b may be tactile buttons that users press to perform specific actions. These buttons can be mechanical or capacitive. These buttons may be arranged in various patterns or configurations, such as individual buttons or grouped layouts, depending on the functionality needed by the system. Digital operational keys 108b are virtual buttons associated with the user interface of user device, such as a touchscreen. Digital buttons may not involve physical contact with a traditional switch; instead, the interface detects touch or gesture input on a display screen.

Each operational key 108b may be mapped to a specific movable barrier operator of the plurality of MBOs 106. In systems where multiple barriers or operators are in use, these operational keys 108b enable individual control over the MBO 106. For example, each operational key 108b may be dedicated to one MBO 106. Pressing the first operational key 108b on the MBO transmitter 108 might be configured to send a signal to control a functional aspect of the first MBO 106, while pressing a second operational key 108b could control a functional aspect of a different gate or barrier associated with a second MBO 106 different from the first MBO 106. When one or more of the operational keys 108b are engaged, the MBO transmitter 108a may send a signal that includes the transmitter identifier 110a-b and a control instruction to the designated MBO 106.

### RECEIVING A TRANSMITTER IDENTIFIER FROM THE MBO TRANSMITTER

With continued reference to FIG. 1, the designated MBO 106 can receive the transmitter identifier 110a from the MBO transmitter 108a. As used in the current disclosure, the transmitter identifier 110a is a unique dataset, including a code or sequence of characters, associated with the MBO transmitter 108. The transmitter identifier 110a may serve as a unique signature for that particular MBO transmitter 108a, allowing for differentiation between multiple MBO transmitters 108a and their corresponding commands. The transmitter identifier 110a may be assigned to the MBO transmitter 108a during the manufacturing process or through programming. Assigning the transmitter identifier 110a is done to ensure that each MBO transmitter 108a within a given system or environment has a unique transmitter identifier 110a.

The MBO transmitter 108a transmits a signal, such as a coded signal, to at least one of the plurality of MBOs 106 or the processor 102. Each of the plurality of MBOs 106 may be equipped with a receiver 107 that is configured to receive the signal transmitted from the MBO transmitter 108a. Upon receiving the signal from the MBO transmitter 108a, the MBO 106 or processor 102 may decode the transmission and extract the transmitter identifier 110a or control instruction from the signal. The MBO 106 or processor 102 may use the decoded transmitter identifier 110a to identify and/or verify the source of the signal as the specific MBO transmitter 108a. In some cases, the transmitter identifier 110a may be encrypted.

In an embodiment, the transmitter identifier 110a may include a plurality of key identifiers 110b each associated with one of the plurality of operational keys 108b on the MBO transmitter 108a. For example, where the MBO transmitter 108a includes three operational keys 108b, the transmitter identifier 110a may include three key identifiers 110b. As used in the current disclosure, the key identifiers 110b are unique codes or sequences of characters that are specifically linked to each operational key 108b. Each key identifier 110b is tied to a specific operational key 108b associated with the MBO transmitter 108. The key identifiers 110b may be used to identify which operational key 108b is being pressed, ensuring that each button sends a distinct signal to the MBO 106. For example, if the MBO transmitter 108a includes several operational keys 108b, wherein each operational key 108b controls a different MBO 106, each operational key 108b might be assigned a unique key identifier 110b. When a user presses one of the operational keys 108b, the MBO transmitter 108a may send the transmitter identifier 110a and the key identifier 110b associated with that button. This allows the processor 102 to understand exactly which operational key 108b was pressed and what command needs to be executed. The key identifiers 110b could be, for example, stored in a memory associated with the MBO transmitter 108a itself or generated dynamically each time the operational key is pressed.

### ASSIGNING THE TRANSMITTER IDENTIFIER TO A USER PROFILE

With continued reference to FIG. 1, the operations may further include assigning the transmitter identifier 110a-b to a user profile 112. As used in the current disclosure, the user profile 112 refers to a collection of data that is related to the user. The user profile 112 may include a variety of information, such as contact information (e.g. name, age, address, email address, phone number), employment information (e.g. job title, job responsibilities, seniority), and the like. The user profile 112 may be stored locally, such as at the MBO 106, remote, such as at a manufacturer server, or the like. By assigning the transmitter identifier 110a-b to the user profile 112, the system 100 can associate the actions and data transmitted by the MBO transmitter 108a-b with the specific user it belongs to. This enables the system 100 to track the user's interactions, preferences, and activities within system 100.

In some implementations, the user profile 112 may include information about the historical MBOs 106 that the user has engaged (interacted) with. This may include information about when and where the user has interacted with the various MBOs 106. The user profile 112 may include, for example, a timestamp detailing when a particular MBO 106 was actuated and/or which MBO transmitter 108a or operational key 108b was used. The user profile 112 may also indicate a pattern of access, such as a time period associated with frequent actuation during certain temporal windows or a particular time of day. The pattern of access stored in the user profile 112 may provide an analytical view of the user’s engagement with MBOs 106. This may include information associated with the frequency, timing, and locations of MBO access.

In an additional embodiment, the user profile 112 may include information regarding the user’s role within the organization (e.g., household or facility) and how it relates to their access to the MBOs 106. The user profile 112 may include information about the duties and tasks that the user is responsible for and/or authorized to initiate. These job functions may dictate the user's interactions with MBOs 106, equipment, and the like.

### DETERMINING AN ACCESS LEVEL ASSOCIATED WITH THE MBO TRANSMITTER

With continued reference to FIG. 1, the operations may further include processing the transmitter identifier 110a-b to determine an access level 114 associated with the MBO transmitter 108a-b. As used in the current disclosure, an access level refers to a set of access permissions associated with specific resource(s) or system(s). The access level 114 may dictate which MBOs 106a user is authorized to open, close, or otherwise manipulate. The access level 114 may be used as a security measure to ensure that users only have access to the areas or MBOs 106 that are relevant to their job responsibilities or specific needs.

The access level 114 may be tailored based on the user's historical access patterns to the MBOs 106. These historical access patterns may be tracked and analyzed over time to determine what MBOs 106 the user interacts with and/or how often the user interacts with said MBO(s) 106. By analyzing historical access patterns, the system 100 can establish a tailored access level 114 that matches the user’s routine activities. For example, if a user regularly accesses certain MBOs 106 as part of their daily tasks, the system 100 can automatically group these MBOs 106 together into a specific access level 114.

Additionally, the user’s job responsibilities, as defined by their user profile 112, may be used to determine the access level 114. The user profile 112 provides context for how the user interacts with the environment and what types of access are necessary for their tasks. This context is useful because different job functions require access to different resources and systems, and this is reflected in the user profile 112. For instance, a user with a job title such as a security officer might have access to a different set of MBOs 106 as compared to a delivery driver, as their job functions differ significantly.

### IDENTIFYING A SUBSET OF MOVABLE BARRIER OPERATORS FROM THE BROADER GROUP OF AVAILABLE MOVABLE BARRIER OPERATORS

With continued reference to FIG. 1, the operations include identifying a subset of movable barrier operators (MBOs) 116 from the broader group of available MBOs 106 based on the access level 114. As used in the current disclosure, the subset of MBOs 116 refers to a specific set of MBOs 106 that a particular user or user profile 112 is authorized to interact with. The system 100 utilizes the access level 114 to filter and select the appropriate subset of MBOs 116 from the larger pool of available MBOs 106. This process may involve evaluating the permissions and job titles within the user profile 112 to determine which MBOs 106 the user is authorized to operate.

To identify the subset of MBO’s 116, system 100 processes data associated with the user’s access level 114 to generate the corresponding subset of MBOs 116. This is accomplished by cross-referencing the user’s access level 114 with the available MBOs 106. Each MBO 106 may be categorized, for example, based on its location, function, or associated area. The system 100 selects only those MBOs whose categories align with the permissions specified in the user’s access level 114. For example, if a user is authorized to manage MBOs 106 in specific security zones, the system 100 will grant access exclusively to the MBOs 106 within those zones, excluding any outside their scope of access, and thus form the subset of MBOs 116.

In certain cases, historical access data may be used to identify and/or refine the subset of MBOs 116. The access patterns reflected in historical access data help the system 100 adjust the subset of MBOs 116 by adding or removing MBOs based on the user’s past behavior. For instance, if a user consistently accesses a particular set of MBOs during their shifts, the system 100 can update the subset of MBOs 116 and adjust the access level 114 to reflect these habitual actions, ensuring that the user’s access remains aligned with their actual usage patterns.

In an embodiment, system 100 may use a lookup table, or other reference source, to identify the subset of MBOs 116. As used in the current disclosure, a lookup table is a data structure used to retrieve information based on specific search criteria or keys. The lookup table may serve as a reference tool to map access levels 114 to the appropriate subset of MBOs 116. In an embodiment, the lookup table may store a set of predefined relationships between access levels, user profiles, and the corresponding MBOs. When the system needs to determine which MBOs a user is allowed to interact with, the system 100 can quickly reference the lookup table to make this determination.

The lookup table may include a plurality of entries, wherein each entry represents the user's access level, job role, or department, and corresponding values that list the specific MBOs the user is permitted to access. The lookup table may include mappings that allow the system to quickly retrieve the relevant MBOs based on the user profile’s attributes, including their role, department, and historical access patterns. For example, an entry in the lookup table might associate a particular access level 114 with a subset of MBOs 116 based on the user’s job title or job functions.

### AFFECTING A SET OF ACCESS PERMISSIONS BETWEEN THE MBO TRANSMITTER AND THE SUBSET OF MOVABLE BARRIER OPERATORS BASED ON THE ACCESS LEVEL

With continued reference to FIG. 1, the operations further include affecting a set of access permissions 118 between the MBO transmitter 108a-b and the subset of MBOs 116 based on the access level 114. As used in the current disclosure, the access permissions 118 refer to a right that governs a user’s ability to interact with MBOs 106 through the MBO transmitter 108a-b. The set of access permissions 118 between the MBO transmitter 108a-b and the subset of movable barrier operators 116 governs the actions that can be performed on the MBOs 106, based on the commands and signals sent from the MBO transmitter 108a-b. These permissions may define the extent to which the MBO transmitter 108a-b can control, monitor, or interact with each MBO 116 in the subset. The set of access permissions 118 may be directly linked to the user’s access level 114, such as the user’s job title, responsibilities, historical behavior, and the like.

Each access permission within the set of access permissions 118 may be directed to an individual MBO 106. The access permissions 118 may be linked to specific access actions associated with the MBO 106, such as opening, closing, resetting, or reprogramming the MBO 106. These actions define the scope of interaction a user is authorized to have with a given MBO 106. For instance, the access permissions 114 associated with an employee in middle management might allow a user to open and close all the MBOs 106 in a warehouse but might not have permission to reset the MBO’s 106 operational settings. In contrast, the access permissions associated with the general manager might grant the ability to perform resets or adjustments but not to open or close the MBOs 106 under normal conditions. The assignment of these permissions to specific MBOs 106 allows the system 100 to enforce the principle of least privilege, ensuring that users only have the minimum necessary access to perform their tasks.

In an embodiment, the access permissions 118 may include control permissions. As used in the current disclosure, the control permissions define the ability of the MBO transmitter 108a-b to directly manipulate the movement and state of the MBOs 106. These control permissions may allow the MBO transmitter 108a-b to issue commands to a specific MBO 106. These commands may include opening, closing, raising, lowering, locking, and the like of the movable barriers.

The access permissions 118 may also include monitoring permissions. As used in the current disclosure, the monitoring permissions refer to the rights granted to the MBO transmitter 108a-b to receive real-time information about the status and condition of the MBO 106. These permissions allow the transmitter to monitor key parameters such as the current position of the barriers (open, closed, halfway), their operational status (functioning normally, fault detected), and any errors or alerts that may arise during use.

The access permissions 118 may include configuration permissions. As used in the current disclosure, the configuration permissions allow the MBO transmitter 108a-b to adjust the operational settings and parameters of the MBO 106. This could include setting the speed of the MBO 106, programming time delays for automatic opening or closing, or altering sensitivity settings for motion detection. Additionally, this may include changing the operational status of one or more MBOs 106 for system 100.

The access permissions 118 may include administrative permissions. As used in the current disclosure, the administrative permissions give MBO transmitters 108a-b the authority to augment, adjust, or otherwise affect the access permissions 118 or access level 114 for other MBO transmitters 108a-b and MBOs 106. MBO transmitters 108a-b with administrative permissions can affect which MBO transmitters 108a-b are allowed to control specific MBOs 106 or revoke access permissions from existing MBO transmitters 108a-b. This may include establishing new access levels 114, such as granting certain MBO transmitters 108a-b full control over the MBOs 106, while limiting others to monitoring or restricted control. Additionally, these permissions may allow the configuration of access schedules, ensuring that certain transmitters have operational control only during specified times or under specific conditions.

Affecting a set of access permissions 118 may involve making changes to the access rights or privileges associated with specific operational keys 108b or MBO transmitters 108a. This process may include actions such as pairing or unpairing the transmitter identifier 110a or key identifier 110b with an MBO within the subset of MBOs 116. Affecting access permissions can also involve reassigning permissions between different MBOs 106, operational keys 108b, MBO transmitter 108a, or updating the access rights associated with specific key identifiers 110b. For example, an administrator may change the access level of a transmitter, allowing it to have new control capabilities or restricting its functions to specific tasks, such as monitoring only.

Pairing refers to the process of associating a particular operational key 108b or MBO transmitter 108a with a specific MBO 106, thereby granting the operational key 108b or MBO transmitter 108a the appropriate access permissions to control, monitor, or configure that MBO 106. During this pairing process, the access permissions for the operational key 108b or MBO transmitter 108a are mapped to the capabilities and limitations associated with the MBO 106, such as whether it can open/close barrier(s), adjust settings, or only monitor the barrier's status.

Pairing the operational key or MBO transmitter 108a-b with a specific MBO 106 may involve assigning at least one access permission from the set of access permissions 118 to each key identifier 110b. This process ensures that each operational key is mapped to a specific set of access permissions that are associated with a particular MBO 106. By doing so, each key identifier 110b is linked to a defined access permission 118 that determines the scope of actions the operational key can perform within the system. For instance, a first access permission associated with the first MBO may be mapped to a first key identifier 110b associated with a first operational key. This may allow the system to engage the MBO based on the engagement of the first operational key.

Unpairing, on the other hand, is the process of disconnecting the association between the operational key or MBO transmitter 108a-b and a particular MBO 106, revoking any previously assigned access permissions 118. This may occur when a key is no longer needed, when access needs to be restricted, or when a system reconfiguration is required.

With continued reference to FIG. 1, each access permission of the set of access permissions 118 may be associated with a temporal access window. As used in the current disclosure, the temporal access window refers to a defined time frame within which access to a specific system, resource, or area is granted or restricted. The temporal access window may be used to manage when the MBO can be operated by a user. The temporal access window may be used in conjunction with access permissions 118 to ensure that individuals or systems are only allowed to engage or interact with MBOs during authorized periods. For instance, an employee may be granted a temporal access window to a parking gate only between 8:00 AM and 6:00 PM, with the system automatically denying entry outside of those hours.

In some cases, the temporal access window may be configured in a variety of ways. The temporal access window may be a recurring schedule (e.g., daily, weekly, or monthly) where access is granted during certain hours of the day, or a more one-time, ad-hoc period when access is required for a specific event or purpose. System 100 may manage these temporal access windows in a dynamic fashion, allowing for changes in the time frame, as well as multiple overlapping windows for different users or groups.

In some cases, system 100 may assign a digital credential to a user profile 112 based on a modified set of access permissions 118. As used in the current disclosure, the digital credential refers to a unique piece of data that verifies the identity of the user and grants them the authority to access the system based on their modified set of access permissions 118. The digital credential may include an authentication token or key, username/password combinations, biometric data (such as fingerprints or facial recognition), smart cards, barcodes, and QR codes.

This digital credential may be representative of the user's set of access permissions 118. Each time the user interacts with the system, the system may cross-reference the digital credential against its database of access permissions 118 to determine whether the user is authorized to interact with the selected MBO. For example, if the system assigns a QR code to a user, the code might encode a unique identifier tied to that user’s profile and specific permissions. When scanned, the system will check whether the permissions in the QR code match the access rules for that particular user, such as access hours or location-specific permissions. If the user’s temporal access window has expired or their role has been downgraded, the system will deny access.

### GENERATING AN OPERATOR DATA STRUCTURE

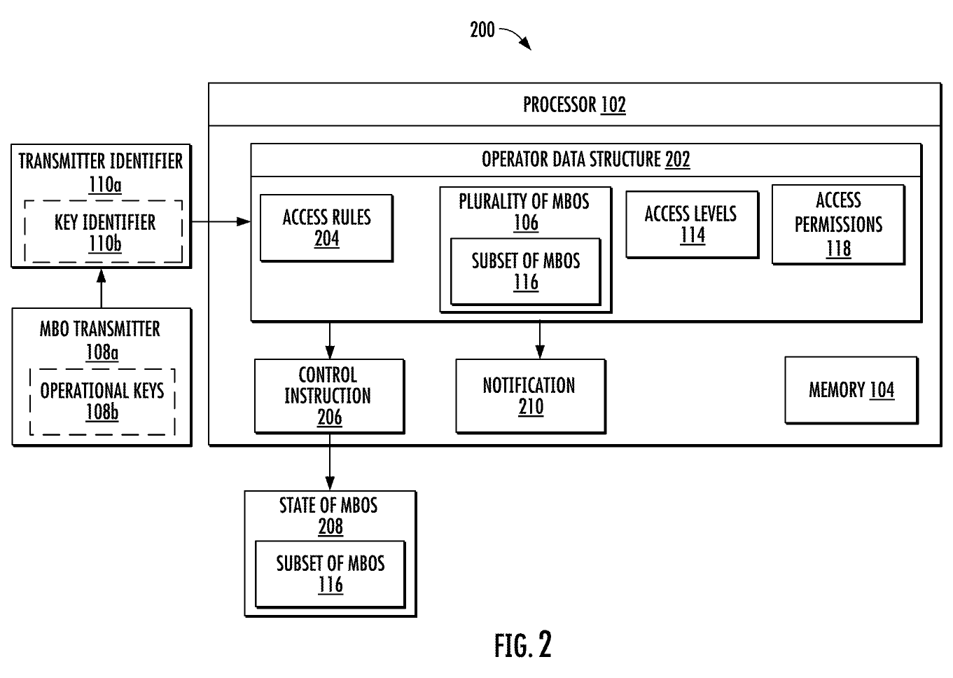

FIG. 2 illustrates an exemplary block diagram of a system for generating and maintaining an operator data structure. FIG. 2 includes an operator data structure 202, access rules 204, control instructions 206, information associated with a state of the MBO 208, notifications 210, and the like.

The operations may include generating the operator data structure 202. As used in the current disclosure, the operator data structure 202 refers to a specialized data structure designed to manage and enforce access permissions between MBOs 106 and the operational keys 108b or MBO transmitters 108a. The operator data structure 202 may be configured to organize and manage the access permissions 118 by defining which user profiles 112 can access the subset of MBOs 116 or operational controls. The operator data structure 202 can store various parameters that define the relationship between users and the subset of MBOs 116. These parameters include access levels 114, user profiles 112, availability of MBOs, job titles, time-based constraints, temporal access windows, access rules 204, and the like. Additionally, rules for the availability of MBOs 106 may also be stored within the operator data structure 202.

The operator data structure 202 may be configured to store a plurality of access rules 204 associated with each MBO 106. The access rule 204 may define the specific permissions, rules, or access level 114 that dictate which MBOs 106 a user is authorized to interact with. For example, the access rule 204 may specify which barriers a user can open, close, or otherwise manipulate based on the associated access level 114. As such, these access rules 204 may be structured according to the user’s role, job responsibilities, or other contextual factors, ensuring that only authorized user profiles 112 can perform certain actions. For example, an access rule might state that only users with a "supervisor" access level are allowed to operate MBOs in high-security areas, while "maintenance" personnel can only manipulate barriers related to their specific tasks.

In some cases, these access rules 204 can be further refined with time-based or location-based conditions, ensuring that users can only access MBOs under certain circumstances. For instance, a user with an employee access level might be allowed to open certain barriers only during specific shifts or hours, while a higher-level user could have broader permissions across the system.

To generate the operator data structure 202, system 200 may structure a list of MBOs 106 with associated properties like their current operational status (active/inactive), assigned tasks associated with a user, time constraints for their operation, and access rules associated with each MBO 106. More specifically, the operator data structure 202 may be designed to manage and structure the complex relationships between access rules 204, access levels 114, user profiles 112, and access permissions 118.

The operator data structure 202 may be used to define the subset of MBOs 116 by associating them with specific access permissions 118. Within the operator data structure 202, the access levels 114 may be represented as keys in a hash table or dictionary, where each key corresponds to a different access level 114. Each access level 114 may be linked to a set of access permissions 118 that define the access that the user profiles 112 have with MBOs. For example, an "Administrator" access level 114 might have access permissions 118 to control all MBOs, while a "Technician" level might be limited to a specific subset of MBOs 116 related to maintenance tasks. These permissions could be stored as a set of actions (e.g., open, close, modify, view) associated with each access level 114.

The user profiles 112 may also be structured to link individual users to their respective access levels 114 and access permissions 118. This may involve creating a user profile database or table, where each record may contain an identifier associated with the user profile 112 along with additional information such as the job title, access level 114, and potentially even additional attributes (e.g., department, location, etc.). Each user profile 112 may also contain references to the specific access rules that apply to them. For example, a user might be granted a particular access level, such as "Technician," and be associated with specific access permissions 118 to operate barriers in a maintenance area.

The access rules 204 themselves may be stored in a more granular structure, such as a graph or a multi-level hash table, which links the user’s profile 112, access level 114, and specific access permissions 118 to the MBOs they can control. The access rule 204 may define conditions like time-based restrictions, geographic limits, or task-specific conditions.

In some cases, the access rules 204 may be organized as key-value pairs where the key is a user profile 112 (or access level 114) and the value is a set of conditions that define access permissions 118, such as a list of barriers that can be controlled, the specific tasks allowed, and any restrictions on access.

The operator data structure 202 may be used to structure the data using a combination of hash tables for fast lookups and trees or graphs for hierarchical or relational data. For example, a hash table might be used to map user IDs to user profile 112, with each user profile 112 containing information about the user’s access level 114 and corresponding access permissions 118. These hash tables may be connected to other data structures that store the access rules 204. In some cases, this may include a graph structure where each node represents a specific user or resource, and edges define the relationships or permissions between them.

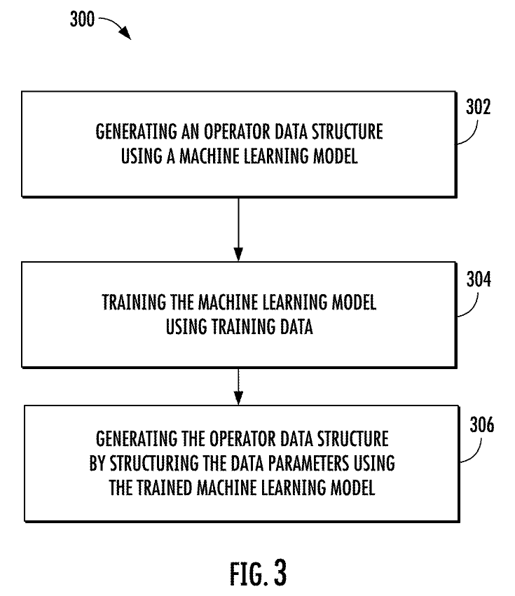

FIG. 3 illustrates an exemplary flow diagram of a method for training a machine-learning model to generate the operator data structure 202.

At step 302, the method includes generating the operator data structure 202 using the machine-learning model. As used in the current disclosure, the machine-learning model is a data structure representing and/or instantiating a mathematical and/or algorithmic representation of a relationship between the various data parameters within the operator data structure 202. The machine-learning model may be trained to structure the unstructured data parameters associated with determining or updating the various access permissions 118. This machine-learning model may structure these data parameters to generate the operator data structure 202. These data parameters may include but are not limited to access rules 204, access levels 114, user profiles 112, access permissions 118, historical access patterns, job titles, job functions, temporal access windows, and any other data disclosed herein.

At step 304, the method includes training the machine-learning model using the training data. The training of the machine-learning model may serve to establish correlations that the machine-learning processes can utilize to model relationships between various categories of data parameters. The training data may include numerous exemplary or historical data parameters associated with determining or updating the various access permissions 118. The machine-learning model may analyze this training data to establish correlations between the data parameters, such as access rules 204 and access levels 114, user profiles 112, access permissions 118, and the like.

The training data may include multiple entries, each representing a collection of recorded, received, or generated data parameters. The data parameters are often correlated through their shared existence within individual entries, their proximity to one another, or other relevant criteria. By analyzing these correlations, the machine-learning model can discern trends, such as the relationship between specific access levels 114 and access permissions 118.

The training data may be structured to highlight the correlations between access levels 114 and access permissions 118. For example, certain job functions might correlate with specific access levels 114 and/or access permissions 118, suggesting a proportional or mathematical relationship between them. By structuring the training data according to the data parameters, the machine-learning model can effectively learn and recognize patterns.

Moreover, the training data may also include elements that are not explicitly categorized. In such cases, machine-learning algorithms can automatically sort the data by employing techniques like correlation detection. The machine-learning model can generate unique access levels 114 based on the inherent relationships found within the data.

In some cases, refined training examples may be selected from a broader population to ensure that they are representative of the various scenarios the machine-learning model may encounter. This selection process aims to cover a range of likely inputs, ensuring the machine-learning model can generalize well when deployed. The chosen training example may reflect a statistically determined distribution, ensuring that more frequently encountered values are represented proportionally within the training data. If any potential training examples are identified as missing, the system can automatically generate these entries by creating correlations within existing data or generating synthetic training data.

Training the machine-learning model may include iteratively updating various parameters, such as coefficients, biases, and weights, based on error evaluations and expected outcomes. This process may include generating an output from the machine-learning model using a specific input example from the training data. The machine-learning model’s output may then be compared to the corresponding output from the training example, leading to the creation of an error function. This error function quantifies the difference between the predicted and actual values. This may be done by calculating the square of the difference between these values.

Once the error function is established, it may be utilized to adjust the machine-learning model’s parameters through techniques like gradient descent, least-squares optimization, or reinforcement learning. This iterative tuning process involves gradually refining the weights, biases, and coefficients of the model based on the calculated error. This is done to help improve the machine-learning model’s accuracy in structuring and creating correlations within the data parameters that make up the operator data structure 202.

The iterative updates continue until the training data is exhausted or a convergence test is achieved. A convergence test assesses whether the model has reached an acceptable level of accuracy, often by comparing the differences between successive error values. When these differences fall below a predefined threshold, it indicates that the model has stabilized, and further training may yield diminishing returns. Additionally, errors from training iterations can be compared to a threshold to determine if the model's performance has met the desired criteria for accuracy.

At step 306, the method includes generating the operator data structure 202 by structuring the data parameters using the trained machine-learning model. Once the machine-learning model is trained, it can utilize classification algorithms to structure the data parameters. By employing techniques such as support vector machines, decision trees, machine-learning algorithms, or neural networks, the machine-learning model assesses the similarity between incoming data parameters and those it has learned during the training phase. This evaluation process may involve evaluating the distances or similarities within a multidimensional feature space.

### UPDATING THE OPERATOR DATA STRUCTURE BASED ON MODIFIED ACCESS PERMISSIONS

With continued reference to FIG. 2, the operations may further include updating the operator data structure 202 based on the modified access permissions 118. This process involves adjusting the access permissions 118 associated with various users and MBOs in response to changes in the system. These changes may include the pairing/unpairing of the MBO transmitter 108a-b with the subset of MBOs 116, updating a user profile 112 (i.e. Job titles, Job Functions, and the like), new/revised access rules 204, and the like. This may also include operational shifts that impact which MBOs are accessible to which access level 114. The goal of updating the operator data structure 202 is to keep the data structure synchronized with the real-world conditions of access control.

Updating the operator data structure 202 may include identifying which user profiles 112 and access levels 114 need to be modified. In a non-limiting example, if the MBO transmitter 108a-b is being paired with the system, updating the operator data structure 202 may include identifying the user profile 112 and its associated access levels 114. Based on this identification, the system may affect the access permissions 118 associated with the user profile 112. This modification may include pairing/unpairing the MBO transmitter 108a or the operational keys 108b with the subset of MBOs 116. These changes may be reflected within the operator data structure 202 once it has been updated. This update of the operator data structure 202 may involve affecting the user profile database or hash table where each user’s access permissions 118 are stored.

With continued reference to FIG. 2, the operations may further include querying the operator data structure 202 in response to engaging the MBO transmitter 108a-b. Engaging the MBO transmitter 108a-b may include receiving a transmitter identifier 110a or key identifiers 110b from the MBO transmitter 108a-b. The system may initiate a query to the operator data structure 202 to validate whether the user has the necessary access permissions 118 to access the specific MBO based on the received transmitter identifier 110a or key identifier 110b. The transmitter identifier 110a or key identifiers 110b serve as a unique identifier for the MBO transmitter 108a-b, allowing the system to determine which user is attempting to access the MBO and what specific credentials are associated with their attempt.

Once the system receives the transmitter identifier 110a or key identifier 110b, it uses it to query the operator data structure. The query process may include matching the transmitter identifier 110a or key identifier 110b to the corresponding user profile 112 within the operator data structure 202. The system will retrieve the user’s profile based on these transmitter identifiers 110a, and then examine the access permissions 118 associated with the user profile 112. These access permissions 118 may be tied to the specific access level 114 defined within the operator data structure 202.

In addition to checking the permissions associated with the user profile 112, the system may verify the operational status of the MBO. If the MBO is in a non-operational state (for example, under maintenance or temporarily disabled), the system may ensure that no access is granted, even if the user profile 112 appears to have the correct permissions. This check may be integrated into the operator data structure 202, where the availability of each MBO may be iteratively updated.

### RECEIVING AND COMMUNICATING THE CONTROL INSTRUCTION

With continued reference to FIG. 2, processor 102 may be instructed to perform operations that comprise receiving a control instruction 206 to control the state 208 of the MBO in response to querying the operator data structure 202. The control instruction 206 be used to manage and/or regulate the operation of a system or device, such as the MBO. The control instruction 206 may specify a desired action or transformation, such as engaging or disengaging a MBO to affect a state of an associated movable barrier. The control instruction 206 may also include instructions that affect the control state of an appliance (e.g., between on and off settings), adjusting settings, initiating a sequence of operations, and the like. When the control instruction 206 is received at the MBO, processor(s) of the MBO may direct a motor or actuator associated with the MBO to perform the specified action, such as raising or lowering the movable barrier. Safety protocols may be embedded in the control signal that halts or pauses the MBO if a blockage of the movable barrier is detected, thereby preventing damage or injury. The control instruction 206 may be issued through various interfaces, including MBO transmitters, remote controls, mobile apps, or automated systems.

The control instruction 206 may act as an operational command, guiding the MBO on whether to open, close, or halt the movement of a movable barrier. When issued, the control instruction 206 may direct the movable barrier operator to respond to user inputs or automated systems with the desired action. For instance, if the control instruction 206 is to open the movable barrier, the MBO interprets this instruction to begin lifting or sliding the movable barrier, depending on its mechanism. Conversely, a control instruction 206 that includes a close instruction may trigger the MBO to move the movable barrier toward the closed position. In addition to basic open and close commands, control instructions 206 may specify detailed movements, such as partial openings or closings. For example, the control instruction 206 might direct the MBO to open the barrier halfway, allowing for partial access. Similarly, the control instruction 206 might require the MBO to close the barrier only partially. The MBO may adjust the movable barrier’s movement based on these control instructions 206, the adjustments may include variations in speed and direction. If the instruction calls for a slow, gradual opening or a quick, abrupt stop, the MBO may adapt accordingly, ensuring the barrier performs precisely as intended.

With continued reference to FIG. 2, the operations may include receiving the control instruction 206 based on querying the operator data structure 202. The control instruction 206 may be generated by system 200 based on the results of querying the operator data structure 202 to determine if the user has the necessary access permissions 118 to operate a specific MBO within the subset of MBOs 116. When a user engages the MBO transmitter 108a-b, the system may query the operator data structure 202, using the transmitter identifier 110a or key identifier 110b to retrieve the corresponding user profile 112 and evaluate the associated access permissions 118. If the query confirms that the user profile 112 has the required access level 114 and permissions to manipulate the MBO in question, the system proceeds to generate the control instruction 206.

With continued reference to FIG. 2, processor 102 may be instructed to perform operations that comprise causing communication of the control instruction 206 to the MBO to control the state 208 of the movable barrier operator. Controlling the state 208 of a movable barrier operator may involve instructing the movable barrier operator to actuate a movable barrier, such as a garage door or gate, into a desired position. Causing communication of the control instruction 206 may include transmitting a command to the movable barrier operator to adjust the position of the movable barrier, such as opening, closing, pausing, and the like of the movable barrier.

Upon receiving the control instruction 206, the MBO may process the command and adjust the movable barrier accordingly. This may involve activating motors or mechanisms associated with the MBO to physically move the barrier to the desired position. For example, if the control instruction 206 is to open the movable barrier, the MBO may initiate the appropriate mechanism to lift or slide the movable barrier. Conversely, if the instruction is to close or partially close the barrier, the MBO may be instructed to adjust the movable barrier’s movement to securely seal off the entry point.

In an embodiment, when a change occurs in the state 208 of the MBO, a notification may be generated to keep users informed of the update. This notification may be then transmitted to a user device. Additionally, the notification may include information about any of the operations that are performed by system 100 or system 200.

### GENERATING A NOTIFICATION BASED ON THE MODIFIED SET OF ACCESS PERMISSIONS

With continued reference to FIG. 2, the operations may further include transmitting, by the computing system, a notification 210 to a user device based on the modified set of access permissions 118. A notification 210 generated based on modified access permissions 118 may be used to inform the user about any changes to their access permissions 118. When access permissions 118 are updated, the system 200 may generate an alert that informs the user of their current access level 114, the subset of MBOs 116 they are authorized to control, and any other relevant permissions or restrictions. For instance, if a user’s access level 114 is modified from a limited role to a more privileged one, the notification 210 might highlight that they now have access to additional movable barrier operators or more extensive control over the system. Alternatively, if a user’s permissions are reduced, the notification 210 may highlight the new limitations.

The notification may include details about the subset of MBOs 116 that the user is now authorized to control. For example, if the user’s access level 114 has been updated to include additional MBOs in a particular area, the notification 210 may explicitly list these MBOs. Additionally, the notification 210 may describe the time frames or other conditions under which the user’s access is valid. In some embodiments, The notification 210 may also include information about which operational keys 108b are assigned to specific MBOs within the subset of MBOs 116. For example, the notification 210 might list operational keys 108b control which MBOs. This may be accompanied by a diagram of the subset of MBOs 116 identifying their location and the specific operational key that controls that MBO.

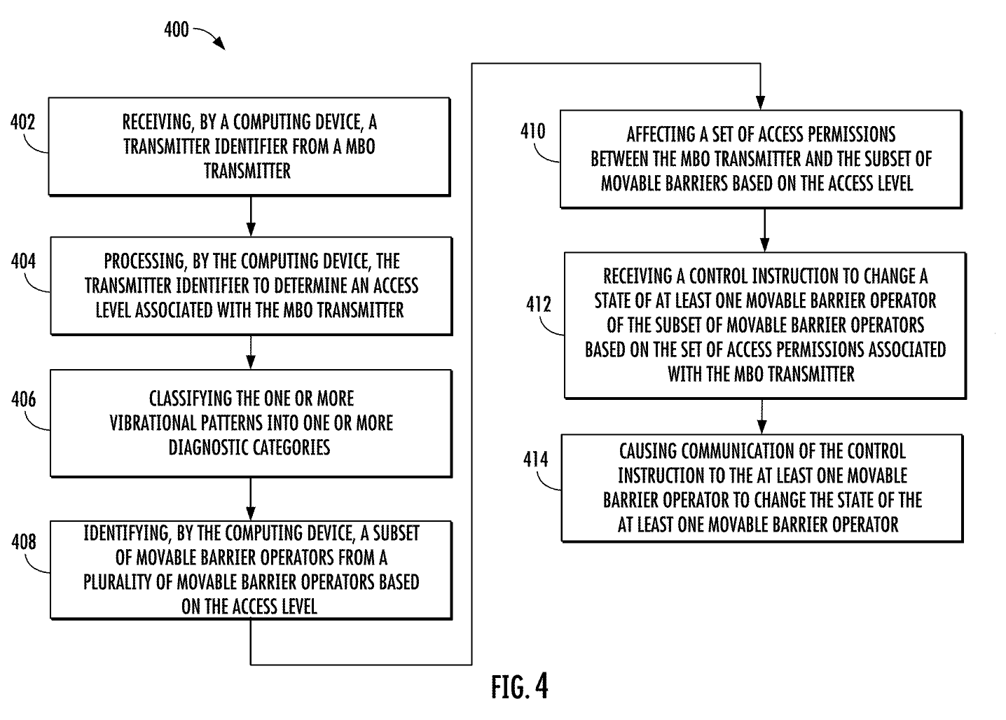

With continued reference to FIG. 4, is a flow diagram of an exemplary method for affecting a set of access permissions associated with a movable barrier operator.

At step 402, the method includes receiving, by a computing device, a transmitter identifier from a MBO transmitter. In an embodiment, the method may include assigning, by the computing device, the transmitter identifier to a user profile.

At step 404, the method includes processing, by the computing device, the transmitter identifier to determine an access level associated with the MBO transmitter.

At step 406, the method includes identifying, by the computing device, a subset of movable barrier operators from a plurality of movable barrier operators based on the access level.

At step 408, the method includes affecting a set of access permissions between the MBO transmitter and the subset of movable barrier operators based on the access level. In an embodiment, affecting the set of access permissions may include pairing/unpairing the transmitter identifier to one or more movable barrier operators of the subset of movable barrier operators. In an additional embodiment, each access permission of the set of access permissions may be associated with a temporal access window.

At step 410, the method includes receiving a control instruction to change a state of at least one movable barrier operator of the subset of movable barrier operators based on the set of access permissions associated with the MBO transmitter.

At step 412, the method includes causing communication of the control instruction to the at least one movable barrier operator to change the state of the at least one movable barrier operator.

In some cases, the MBO transmitter includes a plurality of operational keys. Additionally, the transmitter identifier may include a plurality of key identifiers associated with the plurality of operational keys. Modifications to the set of access permissions may include affecting the set of access permissions between the plurality of key identifiers and the subset of movable barrier operators based on the access level.

In an embodiment, the method may include generating, by the computing device, a notification based on the modified set of access permissions; and transmitting, by the computing device, the notification to a user device.

In an additional embodiment, the method may include updating, by the computing device, an operator data structure based on the affecting; querying, by the computing device, the operator data structure in response to engaging the MBO transmitter; and receiving, by the computing device, the control instruction based on the querying.

Further aspects of the invention are provided by one or more of the following embodiments:

Embodiment 1. A system for affecting a set of access permissions associated with a movable barrier operator is provided. The system includes a plurality of movable barrier operators; a movable barrier operator (MBO) transmitter; one or more processors communicatively connected to the plurality of movable barrier operators and the MBO transmitter; and one or more transitory or non-transitory computer-readable media storing instructions that are executable to cause the one or more processors to perform operations, the operations comprising: receiving a transmitter identifier from the MBO transmitter; processing the transmitter identifier to determine an access level associated with the MBO transmitter; identifying a subset of movable barrier operators from the plurality of movable barrier operators based on the access level; and affecting a set of access permissions between the MBO transmitter and the subset of movable barrier operators based on the access level.

Embodiment 2. The system of embodiment 1, wherein the operations further comprise assigning the transmitter identifier to a user profile.

Embodiment 3. The system of embodiment 1, wherein affecting the set of access permissions comprises pairing the transmitter identifier to the subset of movable barrier operators.

Embodiment 4. The system of embodiment 1, wherein affecting the set of access permissions comprises unpairing the transmitter identifier to the subset of movable barrier operators.

Embodiment 5. The system of embodiment 1, wherein: the MBO transmitter includes a plurality of operational keys; and the transmitter identifier includes a plurality of key identifiers associated with the plurality of operational keys.

Embodiment 6. The system of embodiment 1, wherein the operations further comprise: receiving a control instruction to change a state of at least one movable barrier operator of the subset of movable barrier operators based on the set of access permissions associated with the MBO transmitter; and causing communication of the control instruction to the at least one movable barrier operator to change the state of the at least one movable barrier operator.

Embodiment 7. The system of embodiment 6, wherein the operations further comprise: updating an operator data structure based on the affecting; querying the operator data structure in response to engaging the MBO transmitter; and receiving the control instruction based on the querying.

Embodiment 8. The system of embodiment 1, wherein the operations further comprise: generating a notification based on the modified set of access permissions; and transmitting the notification to a user device.

Embodiment 9. A method for affecting a set of access permissions associated with a movable barrier operator, comprising: receiving, by a computing device, a transmitter identifier from a MBO transmitter; processing, by the computing device, the transmitter identifier to determine an access level associated with the MBO transmitter; identifying, by the computing device, a subset of movable barrier operators from a plurality of movable barrier operators based on the access level; affecting a set of access permissions between the MBO transmitter and the subset of movable barrier operators based on the access level; receiving a control instruction to change a state of at least one movable barrier operator of the subset of movable barrier operators based on the set of access permissions associated with the MBO transmitter; and causing communication of the control instruction to the at least one movable barrier operator to change the state of the at least one movable barrier operator.

Embodiment 10. The method of embodiment 9, wherein the method further comprises assigning, by the computing device, the transmitter identifier to a user profile.

Embodiment 11. The method of embodiment 9, wherein affecting the set of access permissions comprises pairing the transmitter identifier to one or more movable barrier operators of the subset of movable barrier operators.

Embodiment 12. The method of embodiment 9, wherein affecting the set of access permissions comprises unpairing the transmitter identifier to one or more movable barrier operators of the subset of movable barrier operators.

Embodiment 13. The method of embodiment 9, wherein: the MBO transmitter includes a plurality of operational keys; the transmitter identifier includes a plurality of key identifiers associated with the plurality of operational keys; and affecting the set of access permissions comprises affecting the set of access permissions between the plurality of key identifiers and the subset of movable barrier operators based on the access level.

Embodiment 14. The method of embodiment 9, wherein the method further comprises: generating, by the computing device, a notification based on the modified set of access permissions; and transmitting, by the computing device, the notification to a user device.

Embodiment 15. The method of embodiment 9, wherein the method further comprises: updating, by the computing device, an operator data structure based on the affecting; querying, by the computing device, the operator data structure in response to engaging the MBO transmitter; and receiving, by the computing device, the control instruction based on the querying.

Embodiment 16. The method of embodiment 9, wherein each access permission of the set of access permissions is associated with a temporal access window.

Embodiment 17. A system for affecting a set of access permissions associated with a movable barrier operator, comprising: a plurality of movable barrier operators; a movable barrier operator (MBO) transmitter; one or more processors communicatively connected to the plurality of movable barrier operators and the MBO transmitter; and one or more transitory or non-transitory computer-readable media storing instructions that are executable to cause the one or more processors to perform operations, the operations comprising: receiving a transmitter identifier from the MBO transmitter; processing the transmitter identifier to determine an access level associated with the MBO transmitter; identifying a subset of movable barrier operators from the plurality of movable barrier operators based on the access level; affecting a set of access permissions between the MBO transmitter and the subset of movable barrier operators based on the access level; updating an operator data structure based on the modification; receiving a control instruction to change a state of at least one movable barrier operator of the subset of movable barrier operators, wherein receiving the control instruction comprises: querying the operator data structure in response to engaging the MBO transmitter; receiving the control instruction based on the querying; and causing communication of the control instruction to the at least one movable barrier operator to change the state of the at least one movable barrier operator.

Embodiment 18. The system of embodiment 17, wherein the operations further comprise: assigning the transmitter identifier to a user profile; and assigning a digital credential to the user profile based on the modified set of access permissions.

Embodiment 19. The system of embodiment 17, wherein each access permission of the set of access permissions is associated with a temporal access window.

Embodiment 20. The system of embodiment 17, wherein receiving the transmitter identifier comprises scanning a barcode associated with the MBO transmitter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for affecting a set of access permissions associated with a movable barrier operator, the system comprising:
a plurality of movable barrier operators;
a movable barrier operator (MBO) transmitter;
one or more processors communicatively connected to the plurality of movable barrier operators and the MBO transmitter; and
one or more transitory or non-transitory computer-readable media storing instructions that are executable to cause the one or more processors to perform operations, the operations comprising:
receiving a transmitter identifier from the MBO transmitter;
processing the transmitter identifier to determine an access level associated with the MBO transmitter;
identifying a subset of movable barrier operators from the plurality of movable barrier operators based on the determined access level; and
affecting a set of access permissions between the MBO transmitter and the subset of movable barrier operators based on the determined access level.

2. The system of claim 1, wherein the operations further comprise assigning the transmitter identifier to a user profile.

3. The system of claim 1, wherein affecting the set of access permissions comprises pairing the MBO transmitter to the subset of movable barrier operators.

4. The system of claim 1, wherein affecting the set of access permissions comprises unpairing the MBO transmitter from at least one of the subset of movable barrier operators.

5. The system of claim 1, wherein:
the MBO transmitter includes a plurality of operational keys; and
the transmitter identifier includes a plurality of key identifiers, wherein each key identifier of the plurality of key identifiers is associated with one of the plurality of operational keys.

6. The system of claim 1, wherein the operations further comprise:
receiving a control instruction to change a state of at least one movable barrier operator of the subset of movable barrier operators based on the set of access permissions associated with the MBO transmitter; and
causing communication of the control instruction to the at least one movable barrier operator to change the state of the at least one movable barrier operator.

7. The system of claim 6, wherein the operations further comprise:
updating an operator data structure based on the affecting;
querying the operator data structure in response to engaging the MBO transmitter; and
receiving the control instruction based on the querying.

8. The system of claim 1, wherein the operations further comprise:
generating a notification based on the affected set of access permissions; and
transmitting the notification to a user device.

9. A method for affecting a set of access permissions associated with a movable barrier operator, comprising:
receiving, by a computing device, a transmitter identifier from an MBO transmitter;
processing, by the computing device, the transmitter identifier to determine an access level associated with the MBO transmitter;
identifying, by the computing device, a subset of movable barrier operators from a plurality of movable barrier operators based on the access level;
affecting a set of access permissions between the MBO transmitter and the subset of movable barrier operators based on the access level;
receiving a control instruction to change a state of at least one movable barrier operator of the subset of movable barrier operators based on the set of access permissions associated with the MBO transmitter; and
causing communication of the control instruction to the at least one movable barrier operator to change the state of the at least one movable barrier operator.

10. The method of claim 9, wherein the method further comprises assigning, by the computing device, the transmitter identifier to a user profile.

11. The method of claim 9, wherein affecting the set of access permissions comprises pairing the MBO transmitter to the subset of movable barrier operators.

12. The method of claim 9, wherein affecting the set of access permissions comprises unpairing the MBO transmitter from at least one of the subset of movable barrier operators.

13. The method of claim 9, wherein:
the MBO transmitter includes a plurality of operational keys;
the transmitter identifier includes a plurality of key identifiers associated with the plurality of operational keys; and
affecting the set of access permissions comprises affecting the set of access permissions between the plurality of key identifiers and the subset of movable barrier operators based on the access level.

14. The method of claim 9, wherein the method further comprises:
generating, by the computing device, a notification based on the affected set of access permissions; and
transmitting, by the computing device, the notification to a user device.

15. The method of claim 9, wherein the method further comprises:
updating, by the computing device, an operator data structure based on the affecting;
querying, by the computing device, the operator data structure in response to engaging the MBO transmitter; and
receiving, by the computing device, the control instruction based on the querying.

16. The method of claim 9, wherein each access permission of the set of access permissions is associated with a temporal access window.

17. A system for affecting a set of access permissions associated with a movable barrier operator, the system comprising:
a plurality of movable barrier operators;
a movable barrier operator (MBO) transmitter;
one or more processors communicatively connected to the plurality of movable barrier operators and the MBO transmitter; and
one or more transitory or non-transitory computer-readable media storing instructions that are executable to cause the one or more processors to perform operations, the operations comprising:
receiving a transmitter identifier from the MBO transmitter;
processing the transmitter identifier to determine an access level associated with the MBO transmitter;
identifying a subset of movable barrier operators from the plurality of movable barrier operators based on the access level;
affecting a set of access permissions between the MBO transmitter and the subset of movable barrier operators based on the access level;
updating an operator data structure based on the affecting;
receiving a control instruction to change a state of at least one movable barrier operator of the subset of movable barrier operators, wherein receiving the control instruction comprises:
querying the operator data structure in response to engaging the MBO transmitter;
receiving the control instruction based on the querying; and
causing communication of the control instruction to the at least one movable barrier operator to change the state of the at least one movable barrier operator.

18. The system of claim 17, wherein the operations further comprise:
assigning the transmitter identifier to a user profile; and
assigning a digital credential to the user profile based on the affected set of access permissions.

19. The system of claim 17, wherein each access permission of the set of access permissions is associated with a temporal access window.

20. The system of claim 17, wherein the operations further comprise:
generating a notification based on the affected set of access permissions; and
transmitting the notification to a user device.
